(19) United States
(12) Patent Application Publication
(10) Pub. No.: US 2020/0198406 A1
(43) Pub. Date: Jun. 25, 2020

(54) TREAD FOR A PNEUMATIC TIRE

(71) Applicant: The Goodyear Tire & Rubber Company, Akron, OH (US)

(72) Inventors: Benjamin Philipot, Hettange Grande (FR); Jan Leyssens, Leglise-Beheme (BE); Robin Moia, Metz (FR); Roel Creton, Folschette (LU)

(21) Appl. No.: 16/227,157

(22) Filed: Dec. 20, 2018

(51) Int. Cl. B60C 11/03; B60C 11/12

(52) U.S. Cl. CPC B60C 11/0304; B60C 11/1236; B60C 2011/0367; B60C 2011/1254; B60C 11/1259

(57) ABSTRACT

A tread for a tire includes a first circumferential groove; a second circumferential groove; a third circumferential groove; and a fourth circumferential groove. The first, second, third, and fourth circumferential grooves define first, second, third, fourth, and fifth ribs. The second and fourth ribs include lateral grooves and lateral sipes, each extending in a first angled direction relative to the first circumferential groove across the tire tread. Two lateral sipes are disposed circumferentially between each adjacent pair of lateral grooves.

### FIELD OF INVENTION

The present invention relates to an all-season pneumatic tire with an improved tread, and more particularly, relates to a pneumatic tire tread having improved stiffness and more uniform footprint pressure distribution.

### BACKGROUND OF THE INVENTION

Conventionally, in addition to circumferential main grooves and lateral grooves, tire treads may have sipes on a tread surface in order to demonstrate favorable functional characteristics (e.g., low rolling resistance, good traction, good durability, etc.). An object of the tire is to reduce hydroplaning and improve winter performance without reducing dry performance. The tread of the conventional tire may be equipped with a center block column extending in the tire circumferential direction and block columns arranged in a shoulder portion and separated from the center block column by two circumferential grooves. The tread may thereby guide water from a center circumferential flat plane to both sides by providing grooved blocks of the center block column. The grooved blocks may be made up of two groove portions that are separated from each other by an inclined groove and intersect in the center circumferential flat plane by forming an angle with the inclined groove. Moreover, the tread may discharge snow by providing circumferential grooves that extend at an acute angle with respect to the tire equatorial plane (tire circumferential flat plane).

The conventional tire may further include grooves connecting to the adjacent inclined grooves in the tire circumferential direction (tire rolling direction). These connecting groove may become narrower to equalize the size of the blocks of the center block column. Although making the grooves narrower may be effective with respect to snow-covered road surfaces, steering stability on dry road surfaces may be impacted since the stiffness of the blocks is also altered. Additionally, water discharge performance may be reduced and steering stability on wet road surfaces may be reduced since the grooves that connect with the inclined grooves are inclined in the direction opposite the inclined grooves and thus work against the action of the inclined grooves to guide water from the center circumferential flat plane to both sides and thus detrimentally return the water to the center circumferential flat plane side.

### Definitions

The following definitions are controlling for the disclosed invention.

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the centerplane or equatorial plane EP of the tire.

“Axial” and “Axially” means the lines or directions that are parallel to the axis of rotation of the tire.

“Axially inward” means in an axial direction toward the equatorial plane.

“Axially outward” means in an axial direction away from the equatorial plane.

“Bead” or “bead core” generally means that part of the tire comprising an annular tensile member of radially inner beads that are associated with holding the tire to the rim.

“Belt structure” or “reinforcement belts” or “belt package” means at least two annular layers or plies of parallel cords, woven or unwoven, underlying the tread, unanchored to the bead, and having both left and right cord angles in the range from 18 degrees to 30 degrees relative to the equatorial plane of the tire.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” most often means circular lines or directions extending along the perimeter of the surface of the annular tread perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Directional tread pattern” means a tread pattern designed for specific direction of rotation.

“Elastomer” means a resilient material capable of recovering size and shape after deformation.

“Equatorial plane” means the plane perpendicular to the tire's axis of rotation and passing through the center of its tread; or the plane containing the circumferential centerline of the tread.

“Fiber” is a unit of matter, either natural or man-made that forms the basic element of filaments, characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface under normal load pressure and speed conditions.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means a direction going from one sidewall of the tire towards the other sidewall of the tire.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net to gross” means the ratio of the net ground contacting tread surface to the gross area of the tread including the ground contacting tread surface and void spaces comprising grooves, notches and sipes.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Notch” means a void area of limited length that may be used to modify the variation of net to gross void area at the edges of blocks.

“Outboard side” means the side of the tire farthest away from the vehicle when the tire is mounted on a wheel and the wheel is mounted on the vehicle.

“Ply” means a cord-reinforced layer of rubber coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane of the tire.

“Radial ply tire” means a belted or circumferentially-restricted tire in which at least one ply has cords which extend from bead to bead are laid at cord angles between 65 degrees and 90 degrees with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane.

“Section width” means the maximum linear distance parallel to the axis of the tire and between the exterior of its sidewalls when and after it has been inflated at normal pressure for 24 hours, but unloaded, excluding elevations of the sidewalls due to labeling, decoration, or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Shoulder” means the upper portion of sidewall just below the tread edge.

“Sidewall” means that portion of a tire between the tread and the bead.

“Sidewall insert” means elastomer or cord reinforcements located in the sidewall region of a tire. The insert may be an addition to the carcass reinforcing ply and outer sidewall rubber that forms the outer surface of the tire.

“Sipe” means a groove having a width in the range of 0.2 percent to 0.8 percent of the tread width. Sipes are typically formed by steel blades having a 0.4 to 1.6 mm, inserted into a cast or machined mold.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tangential” and “tangentially” refer to segments of circular curves that intersect at a point through which can be drawn a single line that is mutually tangential to both circular segments.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means the ground contacting portion of a tire.

“Tread element” or “traction element” means a rib or a block element.

“Tread width” (TW) means the greatest axial distance across the tread, when measured (using a footprint of a tire,) laterally from shoulder to shoulder edge, when mounted on the design rim and subjected to a specified load and when inflated to a specified inflation pressure for said load.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Void Space” means areas of the tread surface comprising grooves, notches and sipes.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### SUMMARY OF THE INVENTION

A first tread for a tire in accordance with the present invention includes a first circumferential groove extending in a circumferential direction of the tire; a second circumferential groove extending in the circumferential direction of the tire; a third circumferential groove extending in the circumferential direction of the tire; and a fourth circumferential groove extending in the circumferential direction of the tire, the first, second, third, and fourth circumferential grooves defining first, second, third, fourth, and fifth ribs. The second and fourth ribs include lateral grooves and lateral sipes, each extending in a first angled direction relative to the first circumferential groove across the tire tread. Two lateral sipes are disposed circumferentially between each adjacent pair of lateral grooves. One of the two lateral sipes extends in a first axial direction and has a first width transitioning in the first axial direction to a second wider width adjacent a lateral mid-point of the second and fourth ribs. The other of the two lateral sipes extends in a second axial direction and has a first width transitioning in the second axial direction to a second wider width adjacent a lateral mid-point of the second and fourth ribs. The first axial direction is opposite the second axial direction.

According to another aspect of the first tread, the third rib includes lateral grooves and lateral sipes each extending in a second angled direction relative to the third circumferential groove across the tire tread. Two lateral sipes are disposed circumferentially between each pair of adjacent lateral grooves. One of the two lateral sipes extends in the first axial direction and has a first width transitioning in the first axial direction to a second wider width adjacent a lateral mid-point of the third rib. The other of the two lateral sipes extends in the second axial direction and has a first width transitioning in the second axial direction to a second wider width adjacent a lateral mid-point of the third rib. The first angled direction is equal and opposite the second angled direction.

According to still another aspect of the first tread, the first rib includes a secondary groove circumferentially extending completely around the first rib.

According to yet another aspect of the first tread, the first rib includes a tertiary groove circumferentially extending completely around the first rib.

According to still another aspect of the first tread, the lateral grooves have a radial depth between 1.0 mm and 4.0 mm.

According to another aspect of the first tread, the lateral sipes have a radial depth between 1.0 mm and 3.0 mm.

According to yet another aspect of the first tread, the fifth shoulder includes one end blind sipes having a radial depth between 1.0 mm and 3.0 mm.

According to still another aspect of the first tread, the first rib includes lateral grooves extending at a first angle relative to the first circumferential groove across the tread.

According to yet another aspect of the first tread, the first rib includes two sipes disposed circumferentially between each pair of lateral grooves, the two sipes extending at the first angle relative to the first circumferential groove across the tread.

According to still another aspect of the first tread, The tire tread as set forth in claim 9 wherein the two sipes have a radial depth between 1.0 mm and 3.0 mm.

A second tread for a tire in accordance with the present invention includes a first circumferential groove extending in a circumferential direction of the tire; a second circumferential groove extending in the circumferential direction of the tire; a third circumferential groove extending in the circumferential direction of the tire; and a fourth circumferential groove extending in the circumferential direction of the tire. The first, second, third, and fourth circumferential grooves define first, second, third, fourth, and fifth ribs. The second and fourth ribs include lateral grooves and lateral sipes. The lateral grooves and the lateral sipes each extends in a first angled direction relative to the first circumferential groove across the tire tread. Two lateral sipes are disposed circumferentially between each pair of lateral grooves. One of the two lateral sipes extending in a first axial direction and having a first width transitioning in the first axial direction to a second wider width adjacent a lateral mid-point of the second and fourth ribs, the other of the two lateral sipes extending in a second axial direction and having a first width transitioning in the second axial direction to a second wider width adjacent a lateral mid-point of the second and fourth ribs. The first axial direction is opposite the second axial direction. The third rib includes lateral grooves and lateral sipes. The lateral grooves and the lateral sipes each extend in a second angled direction relative to the third circumferential groove across the tire tread. Two lateral sipes are disposed circumferentially between each pair of lateral grooves. One of the two lateral sipes extends in the first axial direction and has a first width transitioning in the first axial direction to a second wider width adjacent a lateral mid-point of the third rib. The other of the two lateral sipes extends in the second axial direction and has a first width transitioning in the second axial direction to a second wider width adjacent a lateral mid-point of the third rib. The first angled direction is equal and opposite the second angled direction.

According to another aspect of the second tread, the first rib includes a secondary groove circumferentially extending completely around the first rib.

According to still another aspect of the second tread, the first rib includes a tertiary groove circumferentially extending completely around the first rib.

According to yet another aspect of the second tread, the lateral grooves of the second, third, and fourth ribs have a radial depth between 1.0 mm and 4.0 mm.

According to still another aspect of the second tread, the lateral sipes of the second, third, and fourth ribs have a radial depth between 1.0 mm and 3.0 mm.

According to yet another aspect of the second tread, the fifth shoulder includes one end blind sipes having a radial depth between 1.0 mm and 3.0 mm.

According to still another aspect of the second tread, the first rib includes lateral grooves extending at a first angle relative to the first circumferential groove across the tread.

According to yet another aspect of the second tread, the first rib includes two sipes disposed circumferentially between each pair of adjacent lateral grooves, the two sipes extending at the first angle relative to the first circumferential groove across the tread.

According to still another aspect of the second tread, the two sipes of the first rib have a radial depth between 1.0 mm and 3.0 mm.

### BRIEF DESCRIPTION OF THE DRAWINGS

The present invention will be more clearly understood by the following description of some examples thereof, with reference to the accompanying drawings, in which:

FIG. 1 is a schematic perspective view of an example tire in accordance with the present invention.

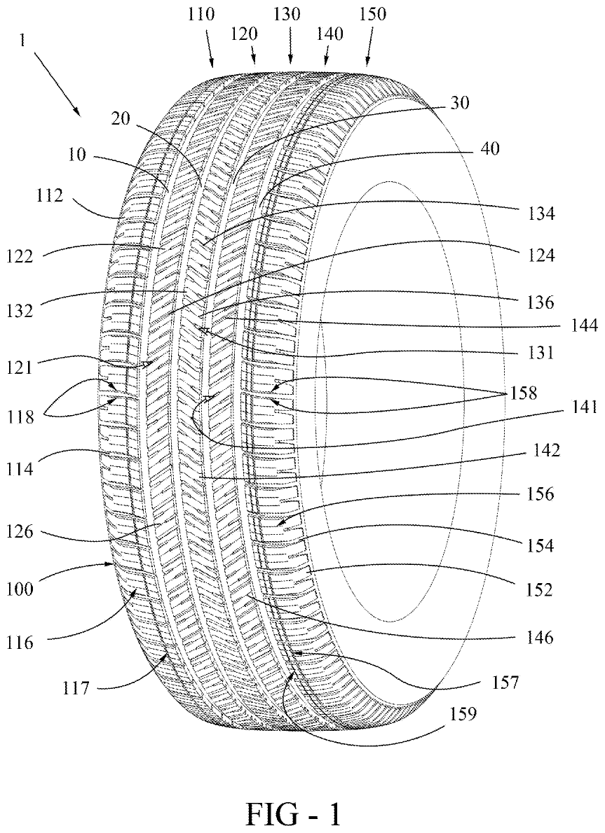

FIG. 2 is a schematic plan view of the tire illustrated in FIG. 1.

FIG. 3 is a schematic enlarged plan view of the tire illustrated in FIG. 1.

FIG. 4 is a schematic sectional view taken along line “4-4” in FIG. 3.

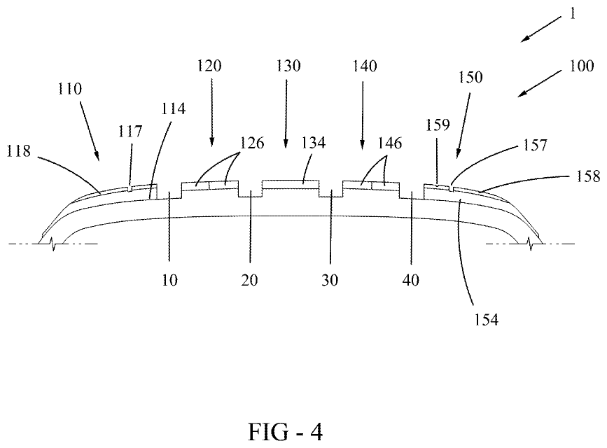

### DESCRIPTION OF EXAMPLES OF THE PRESENT INVENTION

A tire 1 in accordance with the present invention may include a tread 100 with a first main circumferential groove 10, a second main circumferential groove 20, a third main circumferential groove 30, and a fourth main circumferential groove 40 all extending in a circumferential direction C of the tire forming the tread 100. Five land portions, or ribs 110, 120, 130, 140, 150 may be formed by these main circumferential grooves 10, 20, 30, 40. Each of the ribs 110, 120, 130, 140, 150 may have additional grooves and sipes extending laterally L and/or circumferentially C across the ribs 110, 120, 130, 140, 150 forming discreet and circumferentially repeating blocks, or tread elements 112, 122, 132, 142, 152. The main circumferential grooves 10, 20, 30, 40 may have, for example, a lateral width between 3.0 mm and 20.0 mm and an example radial depth between 5.0 mm and 13.0 mm. The tire 1 may be pneumatic or non-pneumatic.

The first shoulder rib 110 may have alternating lateral grooves 114 and one end blind sipes 116 extending axially and at a slight angle from the first main circumferential groove 10 axially toward the outer edge of the tread 100. The lateral grooves 114 may have a radial depth between 1.0 mm and 4.0 mm and the one end blind sipes 116 may have a radial depth between 1.0 mm and 3.0 mm. The bottom of the lateral grooves 114 may have humps or approximately 2.0 mm steps (not shown). The first shoulder rib 114 may further include a secondary groove 117 circumferentially extending completely around the tire 1. The secondary groove 117 may have a radial depth between 2.0 mm and 4.0 mm.

The second shoulder rib 150 may have alternating lateral grooves 154 and one end blind sipes 156 extending axially and at a slight angle from the fourth main circumferential groove 50 axially toward the outer edge of the tread 100. The lateral grooves 154 may have a radial depth between 1.0 mm and 4.0 mm and the one end blind sipes 156 may have a radial depth between 1.0 mm and 3.0 mm. The bottom of the lateral grooves 154 may have humps or approximately 2.0 mm steps (not shown). The second shoulder rib 154 may further include a secondary groove 157 circumferentially extending completely around the tire 1. The secondary groove 157 may have a radial depth between 2.0 mm and 4.0 mm. The second shoulder rib may also have a tertiary groove 159 circumferentially extending completely around the tire 1. The tertiary groove 159 may have a width less than a width of the secondary groove 157, such as 50% of the width of the secondary groove. The tertiary groove 159 may have a radial depth between 2.0 mm and 4.0 mm.

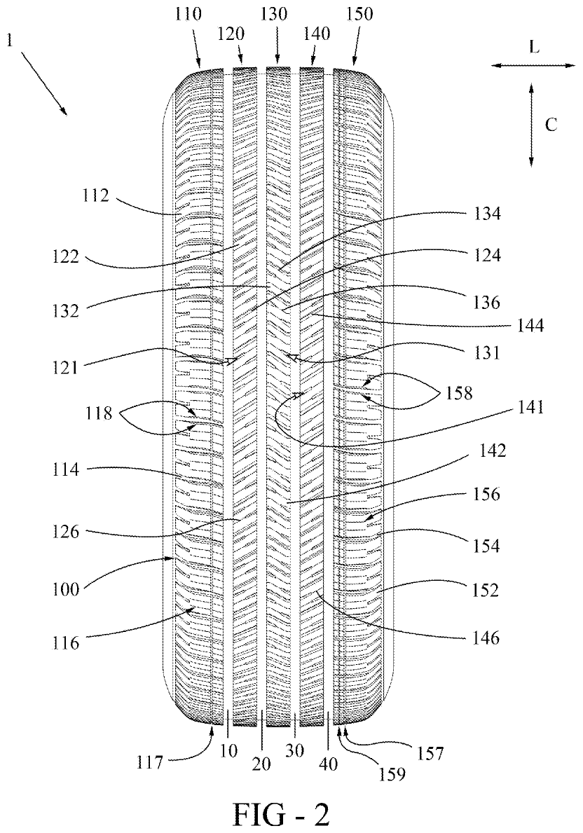

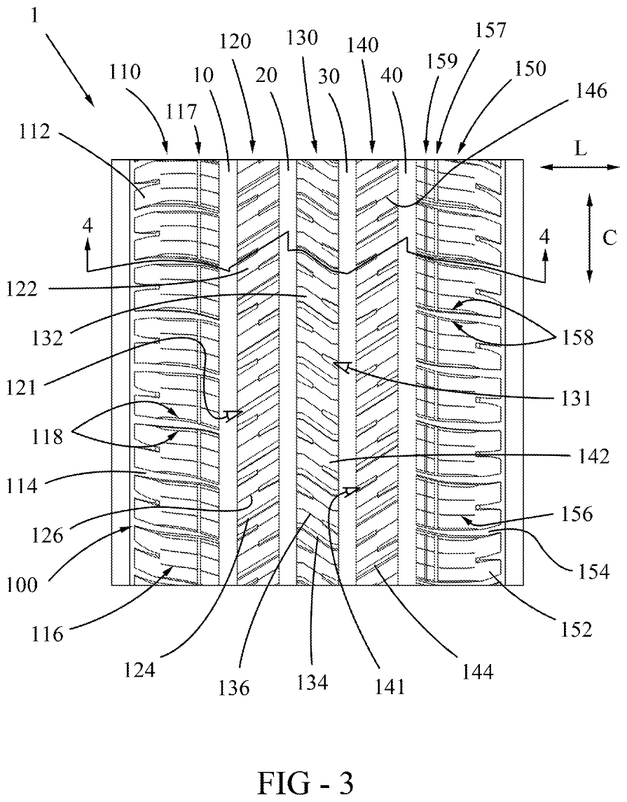

The three center main circumferential ribs 120, 130, 140 may have alternating angled grooves 124, 134, 144 and angled sipes 126, 136, 146 extending axially and circumferentially across the ribs 120, 130, 140 between the corresponding main circumferential grooves 10, 20, 30, 40. The lateral grooves 124, 134, 144 may have a radial depth between 1.0 mm and 4.0 mm and the one end blind sipes 126, 136, 146 may have a radial depth between 1.0 mm and 3.0 mm. As shown in FIGS. 2 and 3, the grooves 124, 144 and sipes 126, 146 of the outer ribs 120, 140 may extend at equal angles while the grooves 134 and sipes 136 of the center rib 130 may extend at an equal, but opposite, angle compared to the angle of the grooves 124, 144 and sipes 126, 146 of the outer ribs 120, 140.

The lateral grooves 124 of the first intermediate rib 120 may extend at a first angle 121 relative to the first circumferential groove 10 across the tire tread 100. Two of the lateral sipes 126 may be disposed circumferentially between each pair of lateral grooves 124. One of the two lateral sipes 126 may extend in a first axial direction and have a first width transitioning in the first axial direction to a second wider width adjacent a lateral mid-point of the first intermediate rib 120. The other of the two lateral sipes 126 may extend in a second axial direction and have a first width transitioning in the second axial direction to a second narrower width adjacent a lateral mid-point of the first intermediate rib 120. The first axial direction may be opposite the second axial direction (FIG. 3). The bottom of the angled sipes 126 may have humps or approximately 2.0 mm steps (not shown). The angled sipes 126 may have a radial depth between 1.0 mm and 4.0 mm.

The lateral grooves 134 of the center rib 130 may extend at a second angle 131 relative to the third circumferential groove 30 across the tire tread 100. Two of the lateral sipes 136 may be disposed circumferentially between each pair of lateral grooves 134. One of the two lateral sipes 136 may extend in a first axial direction and have a first width transitioning in the first axial direction to a second wider width adjacent a lateral mid-point of the center rib 130. The other of the two lateral sipes 136 may extend in a second axial direction and have a first width transitioning in the second axial direction to a second narrower width adjacent a lateral mid-point of the center rib 130. The first axial direction may be opposite the second axial direction (FIG. 3). The bottom of the angled sipes 136 may have humps or approximately 2.0 mm steps (not shown). The angled sipes 136 may have a radial depth between 1.0 mm and 4.0 mm.

The lateral grooves 144 of the second intermediate rib 140 may extend at a third angle 141 relative to the third circumferential groove 30 across the tire tread 100. Two of the lateral sipes 146 may be disposed circumferentially between each pair of lateral grooves 134. One of the two lateral sipes 146 may extend in a first axial direction and have a first width transitioning in the first axial direction to a second wider width adjacent a lateral mid-point of the second intermediate rib 140. The other of the two lateral sipes 146 may extend in a second axial direction and have a first width transitioning in the second axial direction to a second narrower width adjacent a lateral mid-point of the second intermediate rib 140. The first axial direction may be opposite the second axial direction (FIG. 3). The bottom of the angled sipes 146 may have humps or approximately 2.0 mm steps (not shown). The angled sipes 146 may have a radial depth between 1.0 mm and 4.0 mm.

As shown in FIG. 3, the first angle 121 may be equal to the third angle 141. The second angle 131 may be equal and opposite the first angle 121 and/or the third angle 141. The above described tire 1 and tread 100 may be utilized for all-season electric vehicles because of the tread's heavy load and high torque performance characteristics while maintaining acceptable rolling resistance and comfort performance. The design of the three middle ribs 120, 130, 140 may advantageously increase longitudinal stiffness of the tread 100 by as much as +10 percent. The asymmetric design may increase lateral grip by up to +3 percent. The shoulder sipes 116, 156 also increase lateral grip by as much as +5 percent. Sipe density and radial depth may be adjusted for optimum snow and dry handling performances. These factors result in a tread design that may improve snow, dry, and wet handling performances.

While the present invention has been described in connection with what is considered the most practical example, it is to be understood that the present invention is not to be limited to the disclosed arrangements, but is intended to cover various arrangements which are included within the spirit and scope of the broadest possible interpretation of the appended claims so as to encompass all possible modifications and equivalent arrangements.

What is claimed:

1. A tread for a tire comprising:
a first circumferential groove extending in a circumferential direction of the tire;
a second circumferential groove extending in the circumferential direction of the tire;
a third circumferential groove extending in the circumferential direction of the tire; and
a fourth circumferential groove extending in the circumferential direction of the tire, the first, second, third, and fourth circumferential grooves defining first, second, third, fourth, and fifth ribs,
the second and fourth ribs including lateral grooves and lateral sipes, the lateral grooves and the lateral sipes each extending in a first angled direction relative to the first circumferential groove across the tire tread, two lateral sipes being disposed circumferentially between each pair of lateral grooves, one of the two lateral sipes extending in a first axial direction and having a first width transitioning in the first axial direction to a second wider width adjacent a lateral mid-point of the second and fourth ribs, the other of the two lateral sipes extending in a second axial direction and having a first width transitioning in the second axial direction to a second wider width adjacent a lateral mid-point of the second and fourth ribs, the first axial direction being opposite the second axial direction.

2. The tire tread as set forth in claim 1 wherein the third rib including lateral grooves and lateral sipes, the lateral grooves and the lateral sipes each extending in a second angled direction relative to the third circumferential groove across the tire tread, two lateral sipes being disposed circumferentially between each pair of lateral grooves, one of the two lateral sipes extending in the first axial direction and having a first width transitioning in the first axial direction to a second wider width adjacent a lateral mid-point of the third rib, the other of the two lateral sipes extending in the second axial direction and having a first width transitioning in the second axial direction to a second wider width adjacent a lateral mid-point of the third rib, the first angled direction being equal and opposite the second angled direction.

3. The tire tread as set forth in claim 1 wherein the first rib includes a secondary groove circumferentially extending completely around the first rib.

4. The tire tread as set forth in claim 3 wherein the first rib includes a tertiary groove circumferentially extending completely around the first rib.

5. The tire tread as set forth in claim 1 wherein the lateral grooves have a radial depth between 1.0 mm and 4.0 mm.

6. The tire tread as set forth in claim 1 wherein the lateral sipes have a radial depth between 1.0 mm and 3.0 mm.

7. The tire tread as set forth in claim 1 wherein the fifth rib includes one end blind sipes having a radial depth between 1.0 mm and 3.0 mm.

8. The tire tread as set forth in claim 1 wherein the first rib includes lateral grooves extending at a first angle relative to the first circumferential groove across the tread.

9. The tire tread as set forth in claim 8 wherein the first rib includes two sipes disposed circumferentially between each pair of lateral grooves, the two sipes extending at the first angle relative to the first circumferential groove across the tread.

10. The tire tread as set forth in claim 9 wherein the two sipes have a radial depth between 1.0 mm and 3.0 mm.

11. A tread for a tire comprising:
a first circumferential groove extending in a circumferential direction of the tire;
a second circumferential groove extending in the circumferential direction of the tire;
a third circumferential groove extending in the circumferential direction of the tire; and
a fourth circumferential groove extending in the circumferential direction of the tire, the first, second, third, and fourth circumferential grooves defining first, second, third, fourth, and fifth ribs,
the second and fourth ribs including lateral grooves and lateral sipes, the lateral grooves and the lateral sipes each extending in a first angled direction relative to the first circumferential groove across the tire tread, two lateral sipes being disposed circumferentially between each pair of lateral grooves, one of the two lateral sipes extending in a first axial direction and having a first width transitioning in the first axial direction to a second wider width adjacent a lateral mid-point of the second and fourth ribs, the other of the two lateral sipes extending in a second axial direction and having a first width transitioning in the second axial direction to a second wider width adjacent a lateral mid-point of the second and fourth ribs, the first axial direction being opposite the second axial direction,
the third rib including lateral grooves and lateral sipes, the lateral grooves and the lateral sipes each extending in a second angled direction relative to the third circumferential groove across the tire tread, two lateral sipes being disposed circumferentially between each pair of lateral grooves, one of the two lateral sipes extending in the first axial direction and having a first width transitioning in the first axial direction to a second wider width adjacent a lateral mid-point of the center rib, the other of the two lateral sipes extending in the second axial direction and having a first width transitioning in the second axial direction to a second wider width adjacent a lateral mid-point of the third rib, the first angled direction being equal and opposite the second angled direction.

12. The tire tread as set forth in claim 11 wherein the first rib includes a secondary groove circumferentially extending completely around the first rib.

13. The tire tread as set forth in claim 12 wherein the first rib includes a tertiary groove circumferentially extending completely around the first rib.

14. The tire tread as set forth in claim 13 wherein the lateral grooves have a radial depth between 1.0 mm and 4.0 mm.

15. The tire tread as set forth in claim 14 wherein the lateral sipes have a radial depth between 1.0 mm and 3.0 mm.

16. The tire tread as set forth in claim 15 wherein the fifth rib includes one end blind sipes having a radial depth between 1.0 mm and 3.0 mm.

17. The tire tread as set forth in claim 16 wherein the first rib includes lateral grooves extending at a first angle relative to the first circumferential groove across the tread.

18. The tire tread as set forth in claim 17 wherein the first rib includes two sipes disposed circumferentially between each pair of lateral grooves, the two sipes extending at the first angle relative to the first circumferential groove across the tread.

19. The tire tread as set forth in claim 18 wherein the two sipes have a radial depth between 1.0 mm and 3.0 mm.
